(19) United States
(12) Patent Application Publication
(10) Pub. No.: US 2026/0197210 A1
(43) Pub. Date: Jul. 9, 2026

(54) SIGNAL CONTROL METHOD, SIGNAL CONTROL DEVICE, SIGNAL CONTROL APPARATUS, STORAGE MEDIUM, AND COMPUTER PROGRAM PRODUCT

(71) Applicant: SHENZHEN HUAPTEC CO.,LTD, Shenzhen (CN)

(72) Inventors: Yanwei WANG, Shenzhen (CN); Yin KUANG, Shenzhen (CN); Yanlin XIE, Shenzhen (CN)

(73) Assignee: SHENZHEN HUAPTEC CO.,LTD, Shenzhen (CN)

(21) Appl. No.: 19/021,134

(22) Filed: Jan. 14, 2025

(30) Foreign Application Priority Data
Jan. 6, 2025 (CN) 202510016899.4

(51) Int. Cl. H04L 25/03; G06N 5/048; H04B 1/02

(52) U.S. Cl. CPC H04L 25/03949; G06N 5/048; H04B 1/02

(57) ABSTRACT

Disclosed are a signal control method, a signal control device, a signal control apparatus, a storage medium, and a computer program product. The signal control method includes: calculating an error value and an error change rate between a detection value of a current output signal level and a preset detection value in response to a preset trigger condition, inputting the error value and the error change rate into a preset fuzzy algorithm to determine a fuzzy coefficient adjustment amount corresponding to the error value and the error change rate, and updating a parameter of a coefficient in a PID algorithm based on the fuzzy coefficient adjustment amount, and adjusting a gain value based on the updated PID algorithm to achieve signal control.

### CROSS-REFERENCE TO RELATED APPLICATIONS

This application claims priority to Chinese Patent Application No. 202510016899.4, filed on Jan. 6, 2025, the entire contents of which are incorporated herein by reference.

### TECHNICAL FIELD

The present application relates to the technical field of signal control, and in particular to a signal control method, a signal control device, a signal control apparatus, a storage medium, and a computer program product.

### BACKGROUND

Automatic gain control (AGC) is a common and widely used method to adjust the gain of repeaters and receivers such as communications, radars, and broadcasting to ensure that the received signal at various signal strengths can be maintained at an appropriate level when output, thereby improving the dynamic range of the receiver.

In the related art, a simple positive and negative feedback mechanism is usually used to dynamically adjust the gain of the amplifier to maintain the stability of the output signal. However, when facing complex, nonlinear or time-varying systems, suitable parameter identifier (PID) parameters usually need to rely on debugging control experience and continuous trial and error to adjust, and it is still difficult to adapt to the dynamic changes of the system.

### SUMMARY

The main objective of the present application is to provide a signal control method, a signal control device, a signal control apparatus, a storage medium, and a computer program product, aiming to solve the technical problem that when facing complex, nonlinear or time-varying systems, suitable PID parameters usually need to rely on debugging control experience and continuous trial and error to adjust, and it is still difficult to adapt to the dynamic changes of the system.

In order to achieve the above objective, the present application provides a signal control method, including:
calculating an error value and an error change rate between a detection value of a current output signal level and a preset detection value in response to a preset trigger condition;
inputting the error value and the error change rate into a preset fuzzy algorithm to determine a fuzzy coefficient adjustment amount corresponding to the error value and the error change rate; and
updating a parameter of a coefficient in a PID algorithm based on the fuzzy coefficient adjustment amount, and adjusting a gain value based on the updated PID algorithm to achieve signal control.

In an embodiment, the inputting the error value and the error change rate into the preset fuzzy algorithm to determine the fuzzy coefficient adjustment amount corresponding to the error value and the error change rate includes:
inputting the error value and the error change rate into the preset fuzzy algorithm to obtain a membership value corresponding to the error value and the error change rate respectively;
determining a fuzzy set to which the error value and the error change rate belong based on the membership value; and
determining a fuzzy coefficient adjustment amount corresponding to the error value and the error change rate based on the fuzzy set and a preset fuzzy rule table.

In an embodiment, the fuzzy coefficient adjustment amount characterizes a change range of the gain value.

In an embodiment, the updating the parameter of the coefficient in the PID algorithm based on the fuzzy coefficient adjustment amount includes:
determining the fuzzy coefficient adjustment amount corresponding to the fuzzy set and the membership value belonging to the fuzzy coefficient adjustment amount based on the fuzzy set and the preset fuzzy rule table; and
determining the defuzzification fuzzy coefficient adjustment amount based on the membership degree and the fuzzy coefficient adjustment amount, and updating the coefficient parameters in the PID algorithm based on the defuzzification fuzzy coefficient adjustment amount.

In an embodiment, before the calculating the error value and the error change rate between the detection value of the current output signal level and the preset detection value in response to the preset trigger condition, the method further includes:
defining a fuzzy set of the error value and the error change rate;
determining a number of fuzzy rules based on a number of fuzzy sets;
determining a type of fuzzy coefficient adjustment amount based on the number of fuzzy rules; and
establishing a preset fuzzy rule table based on a type of the fuzzy set and the fuzzy coefficient adjustment amount.

In an embodiment, the calculating the error value and the error change rate between the detection value of the current output signal level and the preset detection value in response to the preset trigger condition includes:
calculating the error value between the detection value and the preset detection value in response to the detection value of the current output signal level being greater than the preset detection value or in response to the detection value of the current output signal level being less than the preset detection value, and an attenuation value of the adjusted gain being greater than a preset threshold; and determining the error change rate based on the error value.

Besides, in order to achieve the above objective, the present application further provides a signal control device, including:
a response module for calculating an error value and an error change rate between a detection value of a current output signal level and a preset detection value in response to a preset trigger condition;
a determining module for inputting the error value and the error change rate into a preset fuzzy algorithm to determine a fuzzy coefficient adjustment amount corresponding to the error value and the error change rate; and
an updating module for updating a parameter of a coefficient in a PID algorithm based on the fuzzy coefficient adjustment amount, and adjusting a gain value based on the updated PID algorithm to achieve signal control.

Besides, in order to achieve the above objective, the present application further provides a signal control apparatus, including: a memory, a processor, and a computer program stored in the memory and executable on the processor, and the computer program is configured to realize the signal control method as described above.

Besides, in order to achieve the above objective, the present application further provides a non-transitory computer-readable storage medium, a computer program is stored in the non-transitory computer-readable storage medium, and when the computer program is implemented by a processor, the signal control method as described above is implemented.

Besides, in order to achieve the above objective, the present application further provides a computer program product, the computer program product includes a computer program, and when the computer program is implemented by a processor, the signal control method as described above is implemented.

One or more technical solutions proposed in this application have at least the following technical effects.

Compared with the related art, a simple positive and negative feedback mechanism is usually used to dynamically adjust the gain of the amplifier to maintain the stability of the output signal. However, when facing complex, nonlinear or time-varying systems, suitable PID parameters usually need to rely on debugging control experience and continuous trial and error to adjust, and it is still difficult to adapt to the dynamic changes of the system. This application calculates an error value and an error change rate between a detection value of a current output signal level and a preset detection value in response to a preset trigger condition, inputs the error value and the error change rate into a preset fuzzy algorithm to determine a fuzzy coefficient adjustment amount corresponding to the error value and the error change rate, and updates a parameter of a coefficient in a PID algorithm based on the fuzzy coefficient adjustment amount, and adjusts a gain value based on the updated PID algorithm to achieve signal control. It can be understood that after calculating the error value and the error change rate in response to the preset trigger condition, the present application inputs the error value and the error change rate into the preset fuzzy algorithm, updates the PID algorithm based on the obtained fuzzy coefficient adjustment amount, and adjusts the gain value based on the updated PID algorithm to achieve signal control. By introducing the fuzzy coefficient adjustment amount to adapt the dynamic changes of the system, it is possible to avoid the problem that when facing complex, nonlinear or time-varying systems, suitable PID parameters usually need to rely on the debugging control experience and continuous trial and error to adjust, and it is still difficult to adapt to the dynamic changes of the system.

### BRIEF DESCRIPTION OF THE DRAWINGS

The accompanying drawings, which are incorporated in and constitute a part of this specification, illustrate embodiments consistent with the present application and together with the description serve to explain the principles of the present application.

In order to more clearly illustrate the technical solutions in the embodiments of the present application or the prior art, the following will briefly introduce the drawings that need to be used in the description of the embodiments or the prior art. Apparently, those skilled in the art can also obtain other drawings based on these drawings without any creative effort.

FIG. 1 is a schematic flowchart of a signal control method according to an embodiment of the present application.

FIG. 2 is a parameter update flowchart of the signal control method according to the present application.

FIG. 3 is a schematic flowchart of the signal control method according to an embodiment of the present application.

FIG. 4 is a trigger flowchart of the signal control method according to the present application.

FIG. 5 is a schematic diagram of the module structure of a signal control method according to the present application.

FIG. 6 is a schematic diagram of the apparatus structure of the hardware operating environment involved in the signal control method in according to the present application.

The realization of the objective, functional characteristics, and advantages of the present disclosure are further described with reference to the accompanying drawings.

### DETAILED DESCRIPTION OF THE EMBODIMENTS

It should be understood that the specific embodiments described herein are only used to explain the technical solutions of the present application and are not used to limit the present application.

In order to better understand the technical solution of the present application, a detailed description will be given below in conjunction with the accompanying drawings and specific implementation methods.

The main solutions of the embodiments of this application are: calculating an error value and an error change rate between a detection value of a current output signal level and a preset detection value in response to a preset trigger condition, inputting the error value and the error change rate into a preset fuzzy algorithm to determine a fuzzy coefficient adjustment amount corresponding to the error value and the error change rate, and updating a parameter of a coefficient in a PID algorithm based on the fuzzy coefficient adjustment amount, and adjusting a gain value based on the updated PID algorithm to achieve signal control.

In the related art, a simple positive and negative feedback mechanism is usually used to dynamically adjust the gain of the amplifier to maintain the stability of the output signal. However, when facing complex, nonlinear or time-varying systems, suitable PID parameters usually need to rely on debugging control experience and continuous trial and error to adjust, and it is still difficult to adapt to the dynamic changes of the system.

This application calculates an error value and an error change rate between a detection value of a current output signal level and a preset detection value in response to a preset trigger condition, inputs the error value and the error change rate into a preset fuzzy algorithm to determine a fuzzy coefficient adjustment amount corresponding to the error value and the error change rate, and updates a parameter of the coefficient in the PID algorithm based on the fuzzy coefficient adjustment amount, and adjusts a gain value based on the updated PID algorithm to achieve signal control. It can be understood that after calculating the error value and the error change rate in response to the preset trigger condition, the present application inputs the error value and the error change rate into the preset fuzzy algorithm, updates the PID algorithm based on the obtained fuzzy coefficient adjustment amount, and adjusts the gain value based on the updated PID algorithm to achieve signal control. By introducing the fuzzy coefficient adjustment amount to adapt the dynamic changes of the system, it is possible to avoid the problem that when facing complex, nonlinear or time-varying systems, suitable PID parameters usually need to rely on debugging control experience and continuous trial and error to adjust, and it is still difficult to adapt to the dynamic changes of the system.

It should be noted that the execution subject of this embodiment can be a computing service device with data processing, network communication and program running functions, such as a tablet computer, a personal computer, a mobile phone, etc., or an electronic device capable of realizing the above functions, etc. The following takes the signal control device as an example to illustrate this embodiment and the following embodiments.

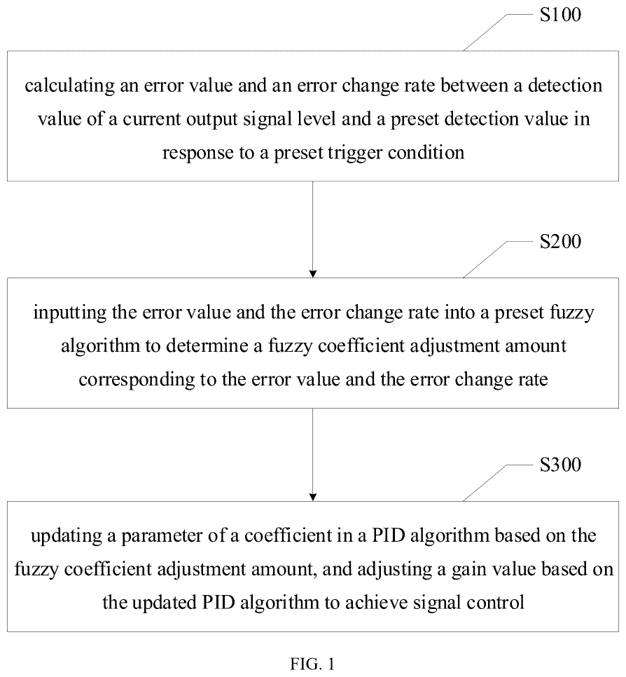

Based on this, an embodiment of the present application provides a signal control method, referring to FIG. 1, FIG. 1 is a schematic flowchart of a signal control method according to an embodiment of the present application.

In this embodiment, the signal control method includes steps S100 to S300:
Step S100, calculating an error value and an error change rate between a detection value of a current output signal level and a preset detection value in response to a preset trigger condition.

It should be noted that the executor of this embodiment is a signal control device, the signal control device may be a Micro Controller Unit (MCU). An error value (e) is a difference between a current coefficient and an actual coefficient. An error change rate (de/dt) represents a rate of change of the error. The signal control device predefines a trigger condition. When meeting the trigger condition, the signal control device starts to calculate the error value (e) between the current output signal level and the preset detection value and the error change rate (de/dt).
Step S200, inputting the error value and the error change rate into a preset fuzzy algorithm to determine a fuzzy coefficient adjustment amount corresponding to the error value and the error change rate.

It is understandable that the fuzzy coefficient adjustment amount is configured to adjust an increment or a decrement of a proportional (Kp), an integral (Ki) and a differentiation (Kd) coefficients of the PID controller. The signal control device feeds the error value (Error) and the error change rate (ΔError) as input variables into the pre-designed fuzzy algorithm to obtain the fuzzy coefficient adjustment amount configured to adjust the increment or decrement of the proportional (Kp), the integral (Ki) and the differentiation (Kd) coefficients of the PID controller.

It should be noted that, since fuzzy logic can handle nonlinear and complex system behaviors and can simulate the knowledge and decision-making process of human experts, the fuzzy PID controller is more flexible and effective than the traditional PID controller when facing nonlinear, time-varying or uncertain systems. Therefore, the step S200 can avoid the problem that when facing complex, nonlinear or time-varying systems, suitable PID parameters usually need to rely on debugging control experience and continuous trial and error to adjust, and it is still difficult to adapt to the dynamic changes of the system.
Step S300, updating a parameter of a coefficient in a PID algorithm based on the fuzzy coefficient adjustment amount, and adjusting a gain value based on the updated PID algorithm to achieve signal control.

It is understandable that the signal control device adjusts the proportional, integral and differentiation coefficients of the PID controller accordingly according to the output of the fuzzy algorithm, that is, the fuzzy coefficient adjustment amount. The updated PID parameters should be able to respond to the current system state more effectively, thereby better controlling the output signal. The control signal is recalculated using the updated PID parameters, and the adjusted control signal is sent to the actuator or control system to adjust the actual output of the system.

Specifically, the PID algorithm defines three control strategies: a proportional control (P), an integral control (I) and a differentiation control (D). The error is processed by integrating the three control strategies of the proportion, the integration and the differentiation and their corresponding gain coefficients, thereby achieving precise control of the output signal.

In an embodiment, the signal control device is also provided with a digitally controlled attenuator, the digitally controlled attenuator is an electronic device configured to accurately control a signal strength, and adjusts its internal attenuation value through a digital input signal, thereby achieving linear or nonlinear attenuation of the input signal. The signal control device calculates the error value between the current signal level detection value and the ideal target signal level detection value. The proportional controller adjusts the gain value according to the error value to control the current output signal level, and responds quickly to eliminate the current deviation. The proportional controller can handle transient deviations, but cannot handle long-term deviations. Therefore, after the proportional controller completes the processing, it enters the integral controller. The integral controller accumulates the cumulative amount of deviations, so that the long-term deviation is gradually reduced to zero, ensuring that the system output can accurately approach the set value and maintain accuracy during long-term operation. Especially when affected by external disturbances or changes in system parameters, the error is quickly compensated to maintain a stable output signal level. The integral gain coefficient adjustment of the integral controller may cause slight system oscillation, so it is necessary to enter the differentiation controller to solve this problem. The following formula is used. The differentiation controller performs feedback adjustment on the rate of change of the error to prevent the system from overreacting to the ideal target point, and can respond immediately to rapid changes to reduce overshoot and oscillation, so as to perfectly improve the dynamic response characteristics of the system. The three controllers reasonably adjust the gain coefficients to balance the steady-state performance and dynamic performance. After the three controllers complete the calculation, the current system gain is adjusted by the MCU to control the digital attenuator, thereby realizing linear or nonlinear attenuation of the input signal.

In an embodiment, step S200 may include the following steps: inputting the error value and the error change rate into the preset fuzzy algorithm to obtain a membership value corresponding to the error value and the error change rate respectively.

It should be noted that the membership value indicates the degree to which the input variable belongs to a specific fuzzy set. The signal control device calculates the membership value of each input variable to each fuzzy set. This value is a number between 0 and 1, indicating the degree to which the input variable belongs to a specific fuzzy set. For example, if the error value is −5, it may have a membership value of 0.8 for “negative large”, a membership value of 0.2 for “negative small”, and a membership value close to 0 for other sets.

Determining a fuzzy set to which the error value and the error change rate belong based on the membership value.

It is understandable that the signal control device may determine the fuzzy set to which the error value and the error change rate most likely belong based on the calculated membership value, and usually, the set with the largest membership value is selected as the representative of the input variable.

Determining a fuzzy coefficient adjustment amount corresponding to the error value and the error change rate based on the fuzzy set and a preset fuzzy rule table.

It should be noted that the preset fuzzy rule table is a predefined table that lists all possible input combinations (the fuzzy set of error value and error change rate) and corresponding outputs (i.e., the adjustment amount of PID parameters), and it is necessary to ensure that the rule base can fully cover these combinations to better provide controllability and stability, making the defuzzification stage more accurate. The signal control device searches for the corresponding rules in the fuzzy rule table according to the fuzzy sets to which the determined error values and error change rates belong. Each rule will generate one or more fuzzy outputs, the fuzzy outputs are also expressed in the form of membership functions. For example, for the proportional gain Kp, the rules may suggest “slightly increase”, “substantially increase” or “remain unchanged”.

In an embodiment, the fuzzy coefficient adjustment amount characterizes a change range of the gain value.

It is understandable that the fuzzy coefficient adjustment amount is configured to characterize the gain value in the fuzzy PID control system. These adjustment amounts are determined through the fuzzy reasoning process and reflect the deviation between the current state of the system and the expected state and the changing trend of this deviation.

In an embodiment, the updating the parameter of the coefficient in the PID algorithm based on the fuzzy coefficient adjustment amount includes:

Determining the fuzzy coefficient adjustment amount corresponding to the fuzzy set and the membership value belonging to the fuzzy coefficient adjustment amount based on the fuzzy set and the preset fuzzy rule table.

It should be noted that the signal control device determines the fuzzy set to which each input variable belongs based on the membership values of the error value and the error change rate, as well as the preset fuzzy rule table. For each fuzzy rule, it will specify a fuzzy output, the fuzzy output represents a degree to which the PID gain should be increased, decreased, or maintained unchanged. At the same time, the membership value of each fuzzy output is calculated, which represents the degree of influence of the rule on the final output.

Determining the defuzzification fuzzy coefficient adjustment amount based on the membership degree and the fuzzy coefficient adjustment amount, and updating the coefficient parameters in the PID algorithm are updated based on the defuzzification fuzzy coefficient adjustment amount.

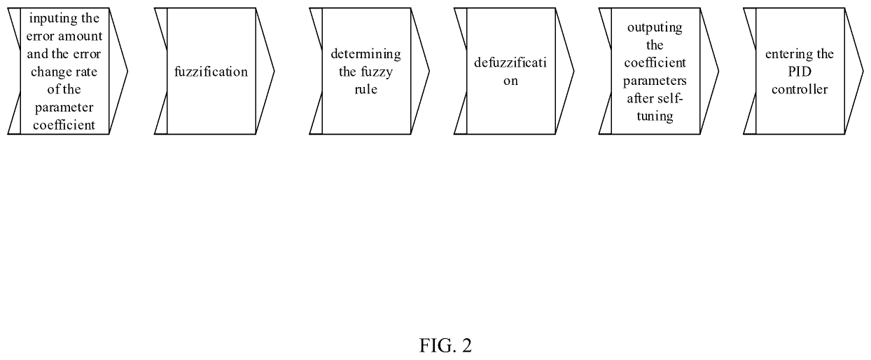

It is understandable that the signal control device converts the fuzzy set into a specific numerical value, that is, the defuzzification fuzzy coefficient adjustment amount, calculates a geometric center of the fuzzy output as a final numerical output, and uses the defuzzification fuzzy coefficient adjustment amount to update the current PID parameters, and applies the updated PID parameters to the control system to adjust a behavior of the controller, referring to FIG. 2, FIG. 2 provides a parameter update flowchart.

In particular, the goal of defuzzification of a signal control device is to extract a specific control value from the fuzzy reasoning result for practical application, convert the fuzzy outputs generated by the fuzzy rule base (such as “increase moderately” and “decrease slightly”) into actual numerical values, calculate the final output value based on the centroid of the fuzzy set using the centroid method, take the calculated centroid (i.e., centroid) of the fuzzy set as the result of defuzzification, and update the proportional, the integral, and the differentiation gain of the PID controller based on the defuzzification result.

Specifically, the updated PID formula is as follows:

### Proportional Controller:

P(t)=Kp*e(t), P(t) is the proportional output part, Kp is the proportional gain coefficient, and e(t) is the time error.

### Integral Controller:

I(t)=Ki*∫e(t)dt, I(t) is the integral output part, Ki is the integral gain coefficient, and e(γ) is the time error.

Differentiation controller, D (t) is the differentiation output part, Kd is the differentiation gain coefficient, e(t) is the moment error, dt is the time interval, and de(t) represents the error change.

In particular, the dt of the PID formula needs to be configured as the MCU operating rate to ensure that the signal control device responds faster. Compared with the traditional automatic gain control method, the feedback strategy is single, when dealing with rapidly changing signal environments, some respond very slowly and cannot adjust the gain in time, resulting in equipment damage. The automatic gain control method of the three controllers after configuration can solve this problem well, with multi-dimensional feedback strategies and fast response speed.

In this embodiment, the signal control device introduces a fuzzy coefficient adjustment amount based on the original PID parameters, which solves the problem that when facing complex, nonlinear or time-varying systems, suitable PID parameters usually need to rely on debugging control experience and continuous trial and error to adjust, and it is still difficult to adapt to the dynamic changes of the system.

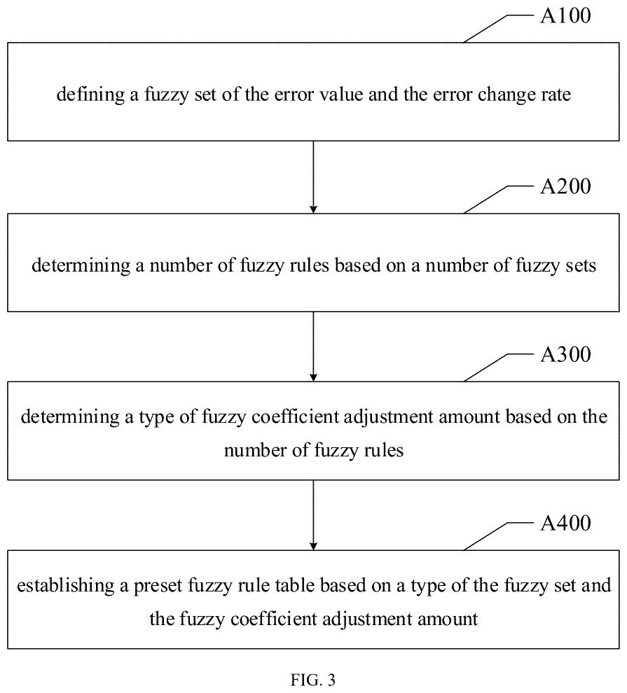

Based on the above embodiment of the present application, in this embodiment of the present application, the same or similar contents as those in the above-mentioned embodiment can be referred to the above introduction, and will not be repeated later. On this basis, please refer to FIG. 3, before the step S100, the signal control method also includes steps A100~A400:
Step A100, defining a fuzzy set of the error value and the error change rate.

It should be noted that, before performing signal control, the signal control device defines appropriate fuzzy sets for the error value and the error change rate. These sets should be able to fully cover the possible input range and have sufficient resolution to capture subtle changes in the system.

Specifically, the error value and the error change rate have corresponding fuzzy sets, as shown below:

### Eerror Value:

Small: small error;
Medium: moderate error;
Large: large error.

### Error Change Rate:

Increasing: the rate of error change is increasing;
Decreasing: the rate of error change is decreasing;
Constant: the rate of error change is stable.
Step A200, determining a number of fuzzy rules based on a number of fuzzy sets.

It is understandable that the signal control device determines the number of fuzzy rules required based on the complexity of the system and the control target. The number of fuzzy rules directly affects the flexibility and response speed of the system. Generally, the more rules there are, the more adaptable the system is, but the greater the computational burden is. The number of rules depends on the number of combinations of input variables and fuzzy sets. For example, if there are three fuzzy sets of control errors and three error change rate sets, there may be 3×3=9 rules.
Step A300, determining a type of fuzzy coefficient adjustment amount based on the number of fuzzy rules.

It should be noted that the signal control device defines a specific adjustment amplitude for each gain, which is achieved by defining a set of fuzzy outputs.

Specifically, the set of fuzzy coefficient adjustment amounts is as follows:
Increase slightly: slightly increase the coefficient;
Increase moderately: moderately increase the coefficient;
Increase significantly: significantly increase the coefficient; Decrease slightly: slightly reduce the coefficient;
Decrease moderately: moderately reduce the coefficient;
Decrease Significantly: significantly reduce the coefficient.
Step A400: establishing a preset fuzzy rule table based on a type of the fuzzy set and the fuzzy coefficient adjustment amount.

It is understandable that the signal control device constructs a fuzzy rule table according to the previously determined fuzzy set, number of rules and adjustment method.

Specifically, the preset fuzzy rule table is shown in table 1:

TABLE 1

| error | error change | coefficient |
|---|---|---|
| value (e) | rate (de/dt) | adjustment (ΔK) |
| small | increasing | increase slightly |
| small | constant | increase moderately |
| small | decreasing | increase moderately |
| medium | increasing | increase moderately |
| medium | constant | increase moderately |
| medium | decreasing | increase slightly |
| large | increasing | increase significantly |
| large | constant | increase moderately |
| large | decreasing | increase significantly |

Specifically, since the signal control device can be applied to a repeater, the preset fuzzy rule table is not fixed, and it is necessary to redesign or adjust the details of the preset fuzzy rule table according to the characteristics, control sensitivity and control requirements of different controlled products.

In an embodiment, the calculating an error value and an error change rate between a detection value of a current output signal level and a preset detection value in response to a preset trigger condition includes:

Calculating the error value between the detection value and the preset detection value in response to the detection value of the current output signal level being greater than the preset detection value or in response to the detection value of the current output signal level being less than the preset detection value, and an attenuation value of the adjusted gain being greater than the preset threshold.

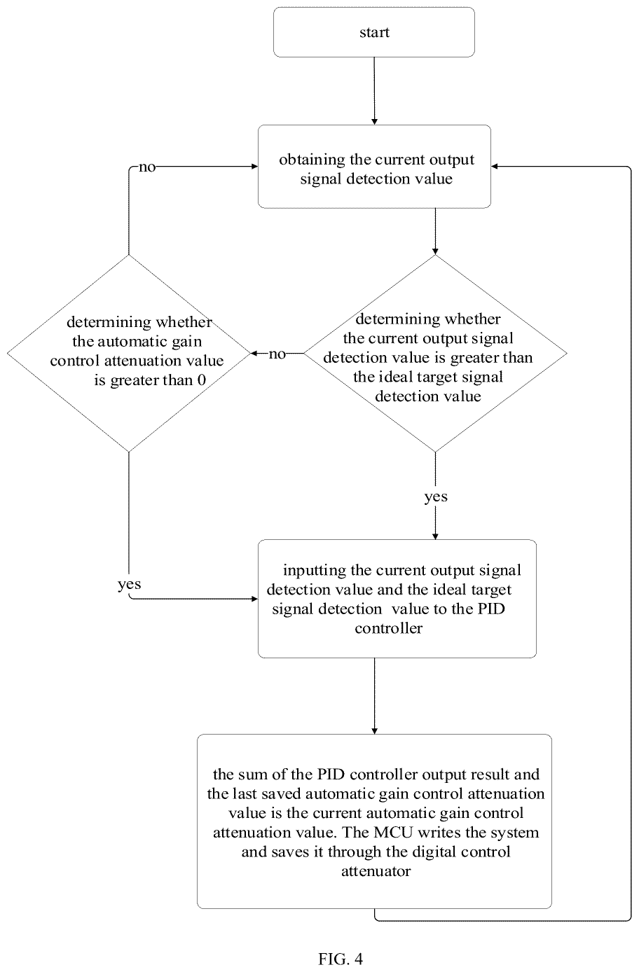

It should be noted that the error value is the difference between the detection value of the current output signal level and the detection value of the ideal output signal level. The signal control device monitors the detection value of the current output signal level and compares it with the preset detection value, referring to FIG. 4, FIG. 4 provides a trigger flowchart. The trigger conditions include two situations:

The detection value of the current output signal level is greater than the preset detection value.

The detection value of the current output signal level is less than the preset detection value.

In addition, there is an additional condition: the attenuation value of the adjusted gain must be greater than the preset threshold, which means that the signal control device not only pays attention to the deviation of the output signal, but also pays attention to the effect of the gain adjustment.

In an embodiment, specifically, before the signal control device performs signal control, it first determines the ideal target output signal level of the repeater. The function of the automatic gain control is to control the output signal to the ideal target output signal level by automatically adjusting the gain.

In particular, if the signal control device detects that the detection value of the current output signal level is less than the detection value of the ideal output signal level, the attenuation value of the adjusted gain is 0, it enters the next round of re-detection to obtain the detection value for judgment.

### Determining the Error Change Rate Based on the Error Value.

It is understandable that the signal control device calculates the error change rate based on the error value.

In this embodiment, by calculating the error value and error change rate, the signal control device can enable the fuzzy PID controller to have a more comprehensive understanding of the system status and dynamically adjust the control parameters based on this information. The introduction of the error change rate not only improves the response speed of the system, but also enhances the stability and robustness of the system, thereby ensuring that the system can quickly and accurately reach the ideal output level.

It should be noted that the above examples are only used to understand the present application and do not constitute a limitation on the signal control method of the present application. More simple transformations based on this technical concept are all within the scope of protection of the present application.

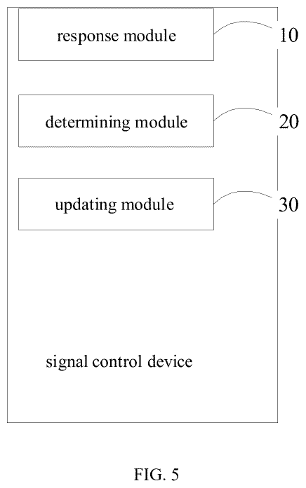

The present application also provides a signal control device, referring to FIG. 5, the signal control device includes:
a response module 10 for calculating an error value and an error change rate between a detection value of a current output signal level and a preset detection value in response to a preset trigger condition;
a determining module 20 for inputting the error value and the error change rate into a preset fuzzy algorithm to determine a fuzzy coefficient adjustment amount corresponding to the error value and the error change rate; and
an updating module 30 for updating a parameter of the coefficient in the PID algorithm based on the fuzzy coefficient adjustment amount, and adjusting a gain value based on the updated PID algorithm to achieve signal control.

The signal control device provided by the present application adopts the signal control method in the above embodiment to solve the technical problem of signal control. Compared with the prior art, the beneficial effects of the signal control device provided by the present application are the same as the beneficial effects of the signal control method provided by the above embodiment, and other technical features in the signal control device are the same as the features disclosed in the above embodiment method, which will not be repeated here.

The present application provides a signal control apparatus, the signal control apparatus includes: at least one processor; and a memory communicated with the at least one processor, the memory stores instructions executable by the at least one processor, and when the instructions are implemented by the at least one processor, the at least one processor implements the signal control method in the above-mentioned embodiment one.

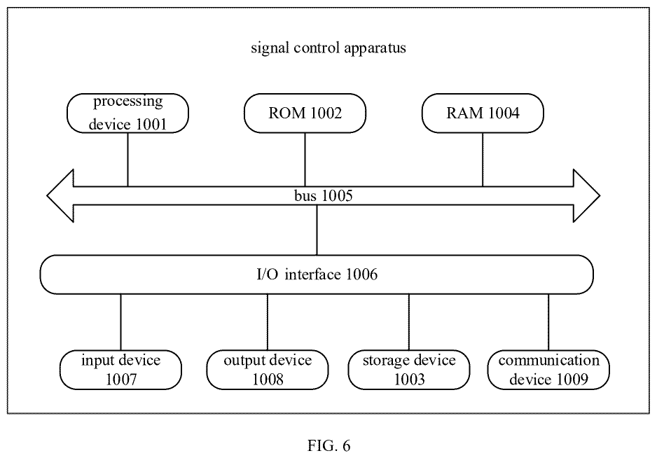

Referring to FIG. 6, FIG. 6 shows a schematic diagram of the apparatus structure of the hardware operating environment involved in the signal control method in according to the present application. The signal control apparatus in the embodiment of the present application may include, but is not limited to, mobile terminals such as a mobile phone, a laptop computer, a tablet computer, a digital broadcast receiver, a Personal Digital Assistants (PDA), a Portable Media Player (PMP), a vehicle-mounted terminal (such as vehicle-mounted navigation terminal), etc., and fixed terminals such as a digital TV, a desktop computer, etc. The signal control device shown in FIG. 6 is only an example and should not impose any limitations on the functions and scope of use of the embodiments of the present application.

As shown in FIG. 6, the signal control device may include a processing device 1001 (e.g., a central processing unit, a graphics processor, etc.), which may perform various appropriate actions and processes according to a program stored in a read-only memory (ROM) 1002 or a program loaded from a storage device 1003 to a random access memory (RAM) 1004. In the RAM 1004, various programs and data required for the operation of the signal control device are also stored. The processing device 1001, the ROM 1002, and the RAM 1004 are connected to each other through a bus 1005. An input/output (I/O) interface 1006 is also connected to the bus 1005. Generally, the following systems may be connected to the I/O interface 1006: an input device 1007 including, for example, a touch screen, a touch pad, a keyboard, a mouse, an image sensor, a microphone, an accelerometer, a gyroscope, etc. An output device 1008 including, for example, a liquid crystal display (LCD), a speaker, a vibrator, etc. A storage device 1003 including, for example, a magnetic tape, a hard disk, etc. and a communication device 1009. The communication device 1009 can allow the signal control device to communicate with other devices wirelessly or wired to exchange data. Although the figure shows a signal control device with various systems, it should be understood that it is not required to implement or have all the systems shown. More or fewer systems can be implemented or have alternatively.

In particular, according to the embodiments disclosed in the present application, the process described above with reference to the flowchart can be implemented as a computer software program. For example, the embodiments disclosed in the present application include a computer program product, the computer program product includes a computer program carried on a computer-readable medium, and the computer program includes a program code for implementing the method shown in the flowchart. In such an embodiment, the computer program can be downloaded and installed from a network through a communication device, or installed from the storage device 1003, or installed from the ROM 1002. When the computer program is implemented by the processing device 1001, the above-mentioned functions defined in the method of the embodiment disclosed in the present application are implemented.

The signal control apparatus provided by the present application adopts the signal control method in the above embodiment to solve the technical problem of signal control. Compared with the prior art, the beneficial effects of the signal control device provided by the present application are the same as the beneficial effects of the signal control method provided by the above embodiment, and other technical features in the signal control device are the same as the features disclosed in the method of the previous embodiment, which will not be repeated here.

It should be understood that the various parts disclosed in this application can be implemented by hardware, software, firmware or a combination thereof. In the description of the above implementation, specific features, structures, materials or characteristics can be combined in any one or more embodiments or examples in a suitable manner.

The above is only a specific implementation of this application, but the protection scope of this application is not limited thereto. Any technician familiar with the technical field can easily think of changes or replacements within the technical scope disclosed in this application, which should be covered within the protection scope of this application. Therefore, the protection scope of this application shall be based on the protection scope of the claims.

The present application provides a computer-readable storage medium having a computer-readable program instruction (i.e., a computer program) stored thereon, the computer-readable program instruction are configured to execute the signal control method in the above-mentioned embodiment.

The computer-readable storage medium provided in the present application may be, for example, a USB flash drive, but is not limited to electrical, magnetic, optical, electromagnetic, infrared, or a semiconductor system, a system or a device, or any combination of the above. More specific examples of computer-readable storage media may include, but are not limited to: an electrical connection with one or more wires, a portable computer disk, a hard disk, a random access memory (RAM), a read-only memory (ROM), an erasable programmable read-only memory (EPROM) or a flash memory, an optical fiber, a portable compact disk read-only memory (CD-ROM), an optical storage device, a magnetic storage device, or any suitable combination of the above. In this embodiment, the computer-readable storage medium may be any tangible medium containing or storing a program, which may be used by or in combination with an instruction execution system, system or device. The program code contained on the computer-readable storage medium may be transmitted using any appropriate medium, including but not limited to: a wires, an optical cable, a Radio Frequency (RF), etc., or any suitable combination of the above.

The computer-readable storage medium may be included in the signal control device; or may exist independently without being assembled into the signal control device.

The above-mentioned computer-readable storage medium carries one or more programs. When the above-mentioned one or more programs are implemented by the signal control apparatus, the signal control apparatus: calculating an error value and an error change rate between a detection value of a current output signal level and a preset detection value in response to a preset trigger condition, inputting the error value and the error change rate into a preset fuzzy algorithm to determine a fuzzy coefficient adjustment amount corresponding to the error value and the error change rate; and updating a parameter of a coefficient in a PID algorithm based on the fuzzy coefficient adjustment amount, and adjusting a gain value based on the updated PID algorithm to achieve signal control.

Computer program code for performing the operations of the present application may be written in one or more programming languages or a combination thereof, the programming languages includes object-oriented programming languages such as Java, Smalltalk, C++, and conventional procedural programming languages such as “C” or similar programming languages. The program code may be implemented entirely on the user's computer, partially on the user's computer, as a separate software package, partially on the user's computer and partially on a remote computer, or entirely on a remote computer or server. In the case of a remote computer, the remote computer may be connected to the user's computer through any type of network, including a local area network (LAN) or a wide area network (WAN), or may be connected to an external computer (e.g., through the Internet using an Internet service provider).

The flowchart and block diagram in the accompanying drawings illustrate the possible architecture, function and operation of the system, method and computer program product according to various embodiments of the present application. In this regard, each square box in the flowchart or block diagram can represent a module, a program segment or a part of a code, and the module, the program segment or a part of the code contains one or more executable instructions for realizing the specified logical function. It should also be noted that in some alternative implementations, the functions marked in the square box can also occur in a sequence different from that marked in the accompanying drawings. For example, two square boxes represented in succession can actually be executed substantially in parallel, and they can sometimes be executed in the opposite order, depending on the functions involved. It should also be noted that each square box in the block diagram and/or flow chart, and the combination of the square boxes in the block diagram and/or flow chart can be implemented with a dedicated hardware-based system that performs a specified function or operation, or can be implemented with a combination of dedicated hardware and computer instructions.

The modules involved in the embodiments described in this application may be implemented by software or hardware. The name of the module does not constitute a limitation on the unit itself in some cases.

The readable storage medium provided in the present application is a computer-readable storage medium, the computer-readable storage medium stores a computer-readable program instruction (i.e., a computer programs) for implementing the above-mentioned signal control method, and can solve the technical problems of signal control. Compared with the prior art, the beneficial effects of the computer-readable storage medium provided in the present application are the same as the beneficial effects of the signal control method provided in the above-mentioned embodiment, and will not be described in detail here.

The present application also provides a computer program product, the computer program product includes a computer program, and when the computer program is implemented by the processor, the above-mentioned signal control method is implemented.

The computer program product provided by the present application can solve the technical problem of signal control. Compared with the prior art, the beneficial effects of the computer program product provided by the present application are the same as the beneficial effects of the signal control method provided by the above-mentioned embodiment, which will not be repeated here.

The above are only some embodiments of the present application, and do not limit the scope of the present application thereto. Under the concept of the present application, equivalent structural transformations made according to the description and drawings of the present application, or direct/indirect application in other related technical fields are included in the scope of the present application.

What is claimed is:

1. A signal control method, comprising:
calculating an error value and an error change rate between a detection value of a current output signal level and a preset detection value in response to a preset trigger condition;
inputting the error value and the error change rate into a preset fuzzy algorithm to determine a fuzzy coefficient adjustment amount corresponding to the error value and the error change rate; and
updating a parameter of a coefficient in a parameter identifier (PID) algorithm based on the fuzzy coefficient adjustment amount, and adjusting a gain value based on the updated PID algorithm to achieve signal control.

2. The signal control method according to claim 1, wherein the inputting the error value and the error change rate into the preset fuzzy algorithm to determine the fuzzy coefficient adjustment amount corresponding to the error value and the error change rate comprises:
inputting the error value and the error change rate into the preset fuzzy algorithm to obtain a membership value corresponding to the error value and the error change rate respectively;
determining a fuzzy set to which the error value and the error change rate belong based on the membership value; and
determining a fuzzy coefficient adjustment amount corresponding to the error value and the error change rate based on the fuzzy set and a preset fuzzy rule table.

3. The signal control method according to claim 2, wherein the fuzzy coefficient adjustment amount characterizes a change range of the gain value.

4. The signal control method according to claim 2, wherein the updating the parameter of the coefficient in the PID algorithm based on the fuzzy coefficient adjustment amount comprises:
determining the fuzzy coefficient adjustment amount corresponding to the fuzzy set and the membership value belonging to the fuzzy coefficient adjustment amount based on the fuzzy set and the preset fuzzy rule table; and
determining the defuzzification fuzzy coefficient adjustment amount based on the membership degree and the fuzzy coefficient adjustment amount, and updating the coefficient parameters in the PID algorithm based on the defuzzification fuzzy coefficient adjustment amount.

5. The signal control method according to claim 1, wherein before the calculating the error value and the error change rate between the detection value of the current output signal level and the preset detection value in response to the preset trigger condition, the method further comprises:
defining a fuzzy set of the error value and the error change rate;
determining a number of fuzzy rules based on a number of fuzzy sets;
determining a type of fuzzy coefficient adjustment amount based on the number of fuzzy rules; and
establishing a preset fuzzy rule table based on a type of the fuzzy set and the fuzzy coefficient adjustment amount.

6. The signal control method according to claim 1, wherein the calculating the error value and the error change rate between the detection value of the current output signal level and the preset detection value in response to the preset trigger condition comprises:
calculating the error value between the detection value and the preset detection value in response to the detection value of the current output signal level being greater than the preset detection value or in response to the detection value of the current output signal level being less than the preset detection value, and an attenuation value of the adjusted gain being greater than a preset threshold; and
determining the error change rate based on the error value.

7. A signal control device, comprising:
a response module for calculating an error value and an error change rate between a detection value of a current output signal level and a preset detection value in response to a preset trigger condition;
a determining module for inputting the error value and the error change rate into a preset fuzzy algorithm to determine a fuzzy coefficient adjustment amount corresponding to the error value and the error change rate; and
an updating module for updating a parameter of a coefficient in a PID algorithm based on the fuzzy coefficient adjustment amount, and adjusting a gain value based on the updated PID algorithm to achieve signal control.

8. A signal control apparatus, comprising: a memory, a processor, and a computer program stored in the memory and executable on the processor, and the computer program is configured to realize the signal control method according to claim 1.

9. A non-transitory computer-readable storage medium, wherein a computer program is stored in the non-transitory computer-readable storage medium, and when the computer program is implemented by a processor, the signal control method according to claim 1 is implemented.

10. A computer program product, wherein the computer program product comprises a computer program, and when the computer program is implemented by a processor, the signal control method according to claim 1 is implemented.
